(19) United States
(12) Patent Application Publication
(10) Pub. No.: US 2019/0065874 A1
(43) Pub. Date: Feb. 28, 2019

(54) SYSTEM AND METHOD OF AUTHENTICATION USING IMAGE OF A USER

(71) Applicant: MASTERCARD INTERNATIONAL INCORPORATED, Purchase, NY (US)

(72) Inventors: Jean-Pierre Gerard, Croton-On-Hudson, NY (US); Steven Klocinski, Riverside, CT (US); Jeremy Pastore, Larchmont, NY (US); Roopa A. Vaidya, Pleasantville, NY (US); Michael L. Zhao, New York, NY (US); Ramamohan Reddy Sangasani, White Plains, NY (US)

(21) Appl. No.: 15/691,400

(22) Filed: Aug. 30, 2017

(51) Int. Cl. G06K 9/00; G06T 7/11

(52) U.S. Cl. CPC G06K 9/00906; G06K 9/00288; G06T 2207/30201; G06T 7/11; G06T 2207/10016; G06K 9/00255

(57) ABSTRACT

A fraud prevention system, method and medium analyzes a fraud prevention image, or a sequence of fraud prevention images, including a facial region of the user and a card associated with the user. The systems, methods and mediums may enable an image parser, a facial recognizer, a communication manager and an authenticator. The image parser may be adapted to parse the fraud prevention image into a facial image and a device image. The facial recognizer may be adapted to analyze the facial image to generate a current facial signature of the user. The authenticator may be adapted to authenticate the user based at least on comparison to the current facial signature and an enrolled facial signature. The communication manager may request a device verification based on a device signature and the authentication of the user. A liveness detector may verify liveness of the user within the fraud prevention image.

### BACKGROUND

Fraudulent activity through electronic communications continues to increase. This fraudulent activity may particularly occur when, e.g., a device used for remuneration during a communication is not physically accessible and present for one of the parties of the communication.

### SUMMARY

Embodiments herein prevent fraud as indicated above by capturing a fraud prevention image of a remuneration device with a person to be authorized during, or after, a communication. The fraud prevention image may be parsed to identify, e.g., unique aspects of the person within the fraud prevention image and particular aspects of the remuneration device within the fraud prevention image. The unique aspects of the person, e.g., a person's face, may be analyzed to verify that the person within the image is authorized to carry out the communication. The aspects of the remuneration device may be analyzed to generate a signature separate from the facial analysis. In embodiments, combining the facial recognition analysis with the signature information, the fraud prevention image may be analyzed for authenticity of the person, including liveness of the person.

In embodiments, a fraud prevention system for authenticating a person/user, includes a processor and memory in communication with the processor. The memory may include a fraud prevention image including a facial region of the user and a remuneration device (e.g., card) region associated with the user. The memory may include computer readable instructions executable by the processor to enable an image parser, a facial recognizer, a communications manager, and an authenticator. The image parser may be adapted to parse the fraud prevention image into a facial image and a card image. The facial recognizer may be adapted to analyze the facial image to generate a current facial signature of the user. The authenticator may be adapted to authenticate the user based at least on comparison to the current facial signature and an enrolled facial signature. The communications manager may be adapted to request a device verification based on the device signature and the comparison of the current facial signature and the enrolled facial signature.

In embodiments, a method for preventing fraud by authenticating a user, includes capturing a fraud prevention image of the user including a facial region of the user and a card region of a card associated with the user. The method may include parsing the fraud prevention image into a facial image and a card image. The method may further include analyzing the facial image to generate a current facial signature. The method may also include analyzing the card image to generate a card signature. The method may include generating an authentication token based on a comparison of the current facial signature to an enrolled facial signature. The method may include requesting a transaction approval based on the card signature and the authentication token.

In embodiments, a non-transitory computer readable medium with computer executable instructions stored thereon executed by a processor to perform fraud prevention, includes instructions for analyzing a fraud prevention image, including a facial region of the user and a card region of a card associated with the user, to generate a current facial signature and a card signature; and, generating an authentication token based on a comparison of the current facial signature to an enrolled facial signature.

### BRIEF DESCRIPTION OF THE FIGURES

FIG. 1 depicts an exemplary system for authentication using an image of a cardholder, in embodiments.

FIG. 2 depicts the user device, of FIG. 1, in further exemplary details, in embodiments.

FIG. 3 depicts an exemplary fraud prevention image having a facial region and a card region, in embodiments.

FIG. 4 depicts another exemplary fraud prevention image having a facial region and a card region, in embodiments.

FIG. 5 depicts another exemplary fraud prevention image having a facial region and a card region, in embodiments.

FIG. 6 depicts a template displayed on a display of a user device, or alternatively on image capture device, providing indicators to aid a user during capture of one or more fraud prevention images, in embodiments.

FIG. 7 depicts an exemplary user device displaying a shopping cart view of a website during operation of the system of FIG. 1, in embodiments.

FIG. 8 depicts an exemplary user device displaying a checkout view of a website during operation of the system of FIG. 1, in embodiments.

FIG. 9 depicts an exemplary method for authentication using an image of a cardholder, in embodiments.

### DETAILED DESCRIPTION OF THE EMBODIMENTS

Communications involving remuneration devices not being present have significant disadvantages, particularly those caused by inability to verify that the person initiating the communication is an authorized user. These disadvantages arise particularly where, e.g., a live person (e.g., cashier) is not present to compare the user initiating the communication to an authentication component, for example, the signature on the back of the remuneration device. Embodiments disclosed herein overcome these disadvantages by allowing such communications to be authenticated at a higher level of scrutiny than merely data comparisons, such as a CVV code, contact information, expiration date, etc.

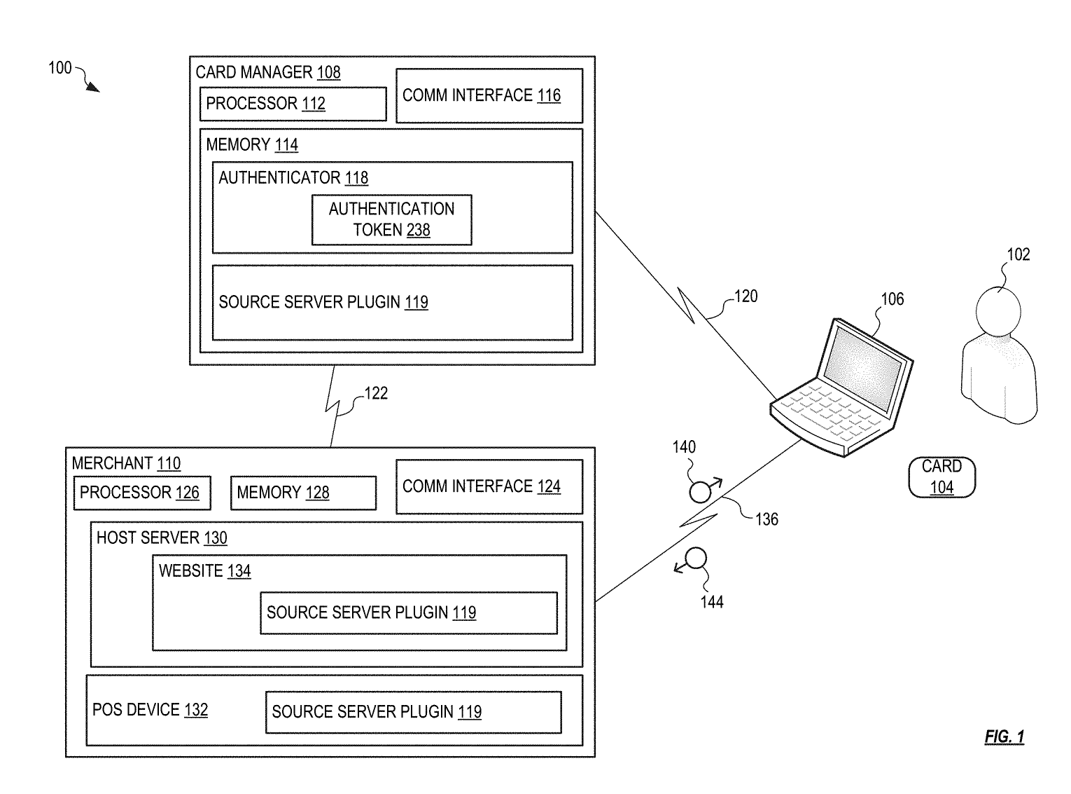

FIG. 1 depicts an exemplary system 100 for authentication using an image of a user to be authorized, in embodiments. System 100 authenticates a user 102 that uses a remuneration device (e.g., card 104) to make a purchase, or other payment, via device 106. Prior to authentication via system 100, it is unknown whether user 102 is an authentic user of card 104, or a fraudulent user. Card 104 represents a remuneration device, such as a credit card, debit card, charge card, prepaid card, gift card, or any other resource that may be used by the user to implement a communication (e.g., a transaction). Device 106 represents a computer, server, mobile device such as a smartphone, tablet, smartwatch, laptop, or other device capable of implementing a card-not-present transaction.

Card 104 may be associated with a card manager 108. In embodiments, card manager 108 may represent (e.g., be a device that is an integral part of) 1) a card provider, such as MasterCard®, Visa®, American Express®, Discover®, and Diners Club® etc., 2) a card issuer, such as Capital One®, Citibank®, Bank of America®, etc. or 3) payment network including both a card provider and a card issuer, such as a three or four-party scheme payment network.

Card manager 108 includes a processor 112 in communication with a memory 114 and a communication interface 116. Memory 114 may include one or both of volatile (e.g. RAM, DRAM, SRAM, etc.) or non-volatile (e.g. ROM, PROM, EEPROM, NVRAM, flash memory, solid-state storage, optical or hard disk drives, etc.) memory. In embodiments, communication interface 116 may be 1) a wired communication protocol, such as telephone, Ethernet, fiber optics, Cable, USB, lighting cable, or other wired communication protocols, 2) a wireless communication protocol, such as WiFi, cellular 2G, 3G, 4G, 5G, LTE, or other wireless communication protocols, or 3) a combination of wired and wireless communication protocols.

Memory 114 may store an authenticator 118 and a source server plugin 119. Authenticator 118 may be stored within memory 114 as transitory or non-transitory computer readable instructions that when executed by processor 112 implement functionality to authorize a transaction attempted associated with card 104. Authenticator 118 may authenticate the transaction based on an authentication token 238 received from device 106 via a first communication link 120 established between communication interface 116 of card manager 108 and a communication interface (not shown in FIG. 1) of device 106. Additional details of authenticator 118, and authentication token 238, are discussed below.

In embodiments, source server plugin 119 may be downloaded from memory 114 to a merchant 110 via a second communication link 122 between a communication interface 124 of merchant 110 and communication interface 116 of card manager 108.

Card 104 may be utilized by user 102 to implement a transaction with merchant 110. Merchant 110 may be a “brick-and-mortar” store, an on-line store, a kiosk, or other merchant that provides goods and/or services. Merchant 110 may include a processor 126 in communication with memory 128 and the communication interface 124.

Memory 128 may include one or both of volatile (e.g. RAM, DRAM, SRAM, etc.) or non-volatile (e.g. ROM, PROM, EEPROM, NVRAM, flash memory, solid-state storage, optical or hard disk drives, etc.) memory. Memory 128 may store computer readable instructions that, when executed by processor 126, implement functionality of a host server 130 and point-of-sale (POS) device 132.

In embodiments, communication interface 124 may be 1) a wired communication protocol, such as telephone, Ethernet, fiber optics, Cable, USB, lighting cable, or other wired communication protocols, 2) a wireless communication protocol, such as WiFi, cellular 2G, 3G, 4G, 5G, LTE, or other wireless communication protocols, or 3) a combination of wired and wireless communication protocols.

Host server 130 may be one or more computers forming a server that hosts website 134. Web site 134 may be accessed by device 106 via a third communication link 136 between communication interface 124 of merchant 110 and a communication interface (not shown in FIG. 1) of device 106. Website 134 may include source server plug-in 119 such that when a transaction with card 104 is attempted by user 102 via device 106, a fraud prevention notification 140 is transmitted to user device 106 requiring user 102 to generate a transaction approval request 144. In embodiments, fraud prevention notification 140 may be generated also from card manager 108 in response to a transaction authorization request from merchant 110 sent to card manager 108. In response to receipt of fraud prevention notification 140, user 102 may interact with website 134, via user device 106, to initiate a communication (e.g. a transaction), for example via generation of transaction approval request 144. It should be appreciated that transaction approval request 144 (e.g. a device verification request) may also be automatically generated from user device 106, for example based on one or more of a card signature, facial signature, and liveness detection as discussed in further detail below.

Host server 130 may be used to implement a quintessential card-not-present transaction—namely, the card 104 may be used in an on-line transaction between user 102 and merchant 110 via user device 106 and website 134. In other words, user 102 may be on-line shopping via the internet. Fraud frequently happens via on-line transactions because the user 102 cannot be readily verified via a live cashier. However, a transaction authorization request from merchant 110 (or card manager 108) may be generated via transactions between user 102 and POS device 132 using card 104. For example, the POS device 132 may also have source server plugin 119 downloaded thereto such that, even with a live transaction (i.e. the user 102 presents card 104 to a live cashier), user 102 is required to respond to fraud prevention notification 140 by generating, using device 106, an authentication token 238. In other words, the embodiments herein are not limited to just on-line transactions, but may also utilize user devices (i.e. device 106) to add an additional level of security for all transactions attempted using card 104.

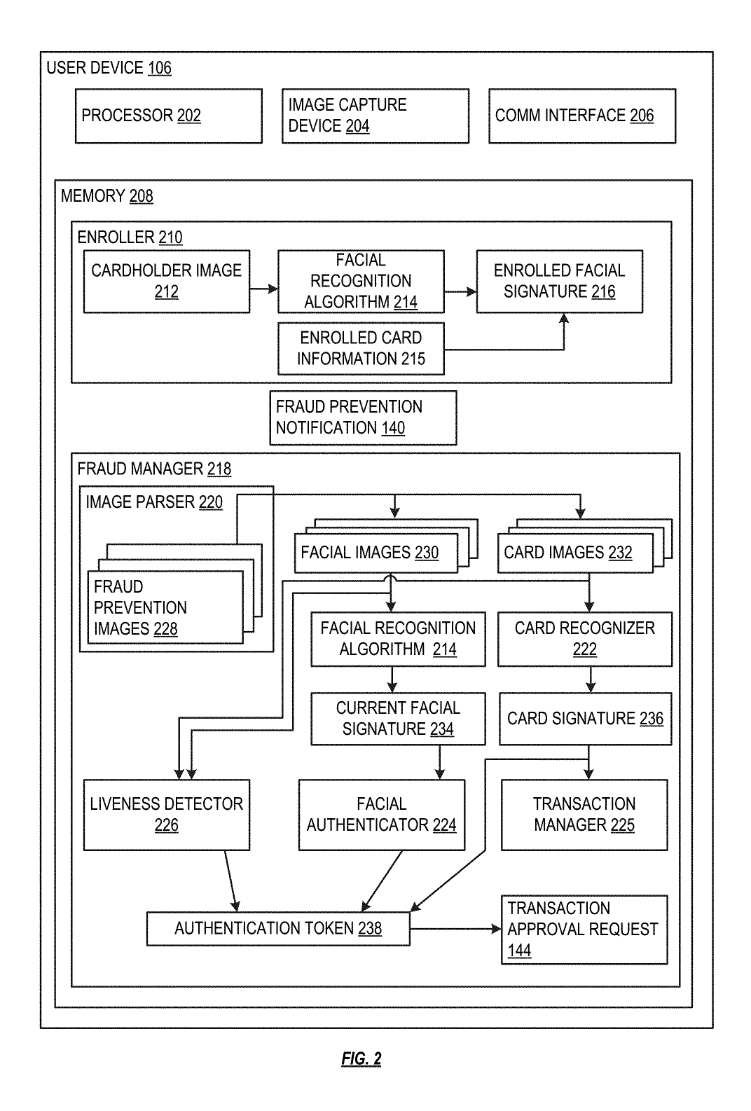

FIG. 2 depicts the user device 106, of FIG. 1, in further exemplary details, in embodiments. User device 106 includes a processor 202 in communication with an image capture device 204, a communication interface 206, and a memory 208.

Image capture device 204 may be an internally located camera capable of capturing images and, in some embodiments, videos. It should be appreciated that image capture device 204 may additionally be externally located and communicate with user device 106 via communications interface 206 such as a wired or wireless connection.

In embodiments, communication interface 206 may be 1) a wired communication protocol, such as telephone, Ethernet, fiber optics, Cable, USB, lighting cable, or other wired communication protocols, 2) a wireless communication protocol, such as WiFi, cellular 2G, 3G, 4G, 5G, LTE, or other wireless communication protocols, or 3) a combination of wired and a wireless communications protocols.

Memory 208 may include one or both of volatile (e.g. RAM, DRAM, SRAM, etc.) or non-volatile (e.g. ROM, PROM, EEPROM, NVRAM, flash memory, solid-state storage, optical or hard disk drives, etc.) memory. In embodiments, memory 208 stores an enroller 210 and a fraud manager 218.

Enroller 210 may be transitory or non-transitory computer readable instructions that, when executed by processor 202, implement at least the following functionality. Enroller 210 may operate to enroll user 102 such that user 102 may respond to a received fraud prevention notification 140. Enroller 210 may activate image capture device 204 to capture a cardholder image 212. Cardholder image 212 may include an image of user 102, for example an image including the facial region of user 102. Enroller 210 may analyze cardholder image 212 based on a facial recognition algorithm 214 to generate an enrolled facial signature 216. Facial recognition algorithm 214 may be configured such that enrolled facial signature 216 includes a mapping, in text or topology form, of features of the face of user 102. For example, enrolled facial signature 216 may include an X,Y coordinate system indicating that one or more of: nose is located in a first X,Y region of cardholder image 212, eyes are located in a second given X,Y region of cardholder image 212, mouth is located in a third X,Y region of cardholder image 212, and ears are located in a fourth X,Y region of cardholder image 212. The totality of first, second, third, and/or fourth X,Y region may indicate a text string forming enrolled facial signature 216. More or fewer facial features may be indicated without departing from the scope hereof. Furthermore, facial recognition algorithm 214 is not limited in scope to analyzing X,Y regions of cardholder image 212, but may use other facial recognition algorithms as known in the art. In embodiments, enrolled facial signature 216 may be associated with enrolled card information 215 which includes information regarding card 104, such as card number, CCV number, expiration date, etc.

In embodiments, enroller 210 operates entirely on user device 106. Therefore, card manager 108, or merchant 110, need not store security related data regarding user 102—namely, cardholder image 212 and/or enrolled facial signature 216. In such embodiments, enroller 210 may operate in response to an enroll control signal (not shown) generated by card manager 108. Enroller 210 may be a stand-alone, or integrated into, an application on user device 106 provided by card manager 108 used in connection with fraud prevention services provided by system 100. In embodiments, enroller 210 may also be implemented within memory 114 of card manager 108 such that the cardholder image 212 is transmitted from image capture device 204 to memory 114, and analyzed via a facial recognition algorithm 214 stored in memory 114 to generate an enrolled facial signature 216 for storage within memory 114 (and optional transmission back to user device 106 for storage in memory 208). In either embodiment, the fraud prevention services provided by system 100 may not be available to a given user 102 until the user enrolls via enroller 210. Additionally, in some embodiments, fraud prevention notification 140 may activate enroller 210 when user 102 is not already enrolled prior to an attempted use of card 104.

Fraud manager 218 may be transitory or non-transitory computer readable instructions that, when executed by processor 202, implement at least the following functionality. In embodiments, fraud manager 218 is activated in response to receipt, by user device 106, of fraud prevention notification 140. In embodiments, fraud manger 218 is activated to initiate generation of transaction approval request 144. Fraud manager 218 may include one or more of an image parser 220, the facial recognition algorithm 214, a card recognizer 222, a facial authenticator 224, a transaction manager 225, and a liveness detector 226.

Fraud manager 218 activates image capture device 204 to capture at least one fraud prevention image 228. In embodiments, fraud manager 218 activates image capture device 204 in response to receipt of fraud prevention notification 140. In embodiments, fraud manager 218 activates image capture device 204 to initiate generation of transaction approval request 144. Image capture device 204 may additionally, or alternatively, be activated in response to a user desiring to attempt a transaction such that functionality of transaction manager 225 is implemented, as discussed below. In embodiments, in response to image capture device 204 being activated, more than one fraud prevention image 228 is captured. For example, in embodiments, these captured fraud prevention images 228 can 1) be individual snapshots or 2) represent a video clip of the user (e.g. user 102). Fraud prevention images 228 include a facial region of the user and a card region of the user. To capture such a fraud prevention image 228, the user may, for example, hold the card up to the side of the user's face during image capture by image capture device 204.

FIG. 3 depicts an exemplary fraud prevention image 228(1) having a facial region 302 and a card region 304, in embodiments. It should be appreciated that facial region 302 and card region 304 are not limited in size, shape, and/or configuration as shown in FIG. 3. For example, each region 302, 304 may be square instead of ovoid in shape. Moreover, each region 302, 304 may overlap. Facial region 302 is shown including the face of user 102.

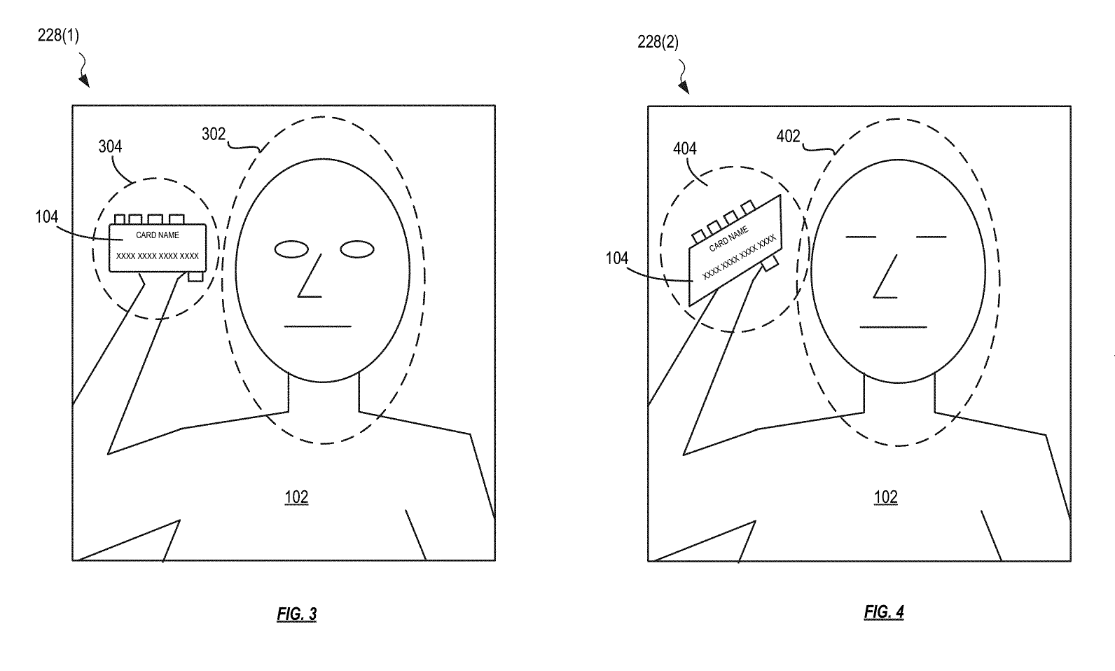

FIG. 4 depicts an exemplary fraud prevention image 228(2) also having a facial region 402 and a card region 404, in embodiments. As shown in FIG. 4 compared to FIG. 3, facial region 402 includes an image where user 102 is blinking. Additionally, compared to FIG. 3, card region 404 includes card 104 in a rotated position. A fraud prevention image 228 including a user blinking may indicate user liveness, as discussed in further detail below. Moreover, it should be appreciated that card region 404 is not the same size as card region 304. Therefore, in embodiments, the characteristics (such as size and shape) of card region and/or the facial region identified by image parser 220 in sequential or different ones of a series of fraud prevention images 228 may differ. For example, in FIG. 4, card region 404 is larger in size because the user is turning card 104 and therefore the region must be larger to fully capture the card.

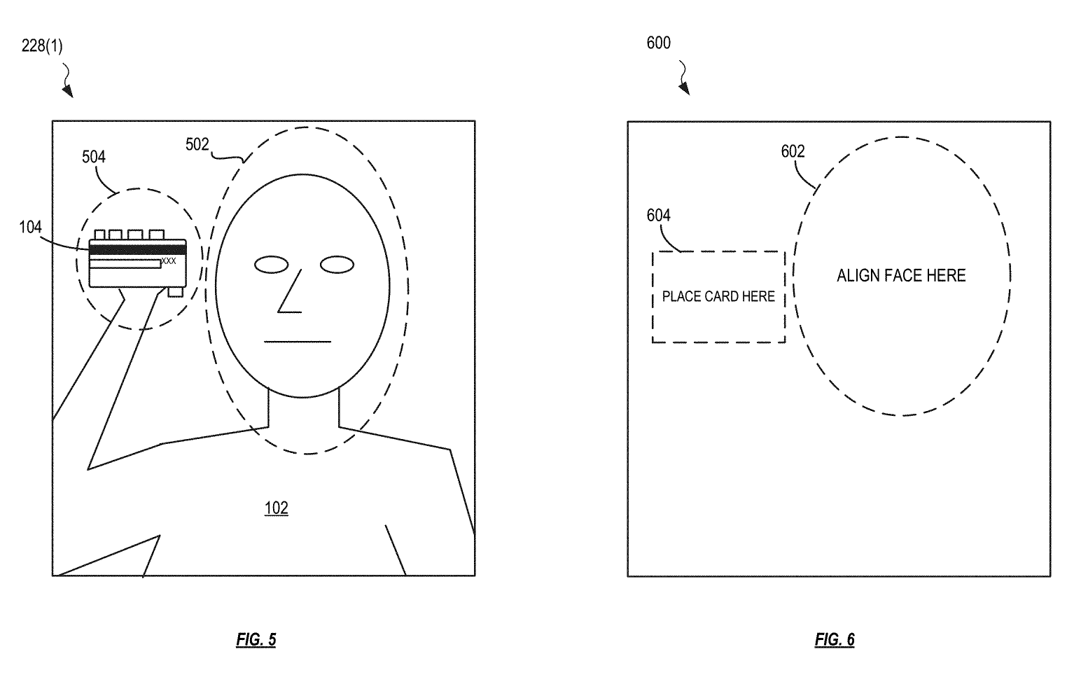

FIG. 5 depicts an exemplary fraud prevention image 228(3) having a facial region 502 and a card region 504, in embodiments. As shown in FIG. 5 compared to FIGS. 3-4, card region 504 includes an image where card 104 has been flipped to show the back thereof by user 102. A fraud prevention image 228 including a flipped card may indicate user liveness as discussed in further detail below. It should be appreciated that there may be more or fewer fraud prevention images 228 than the three shown in FIGS. 3-4 without departing hereof.

FIG. 6 depicts a template 600 displayed on a display of user device 106, or alternatively on image capture device 204, providing indicators to aid user 102 during capture of one or more fraud prevention images 228, in embodiments. For example, if the image capture device 204 is internally located on the user device 106, then the template 600 may be displayed on a display of user device 106. Alternatively, or additionally, if the image capture device 204 is remotely located from user device 106, then template 600 may be displayed on a display of the image capture device 204 to assist the user in capturing the required image. Template 600 displays one or both of a facial indicator 602 and a card indicator 604. Facial indicator 602 may outline a desired region for user 102 to align his/her face when fraud prevention image 228 is being captured by image capture device 204. Card indicator 604 may outline a desired region for user 102 to align card 104 when fraud prevention image 228 is being captured by image capture device 204. It should be appreciated that indicators 602, 604 are not limited in size, shape, or other configuration as shown in FIG. 6.

Referring back to FIG. 2, image parser 220 may include computer readable instructions that, when executed by the processor 202, parse each fraud prevention image 228 into 1) respective facial images 230, corresponding to the facial region (e.g. facial region 302) within the given fraud prevention image 228, and 2) card images 232, corresponding to the card region (e.g. card region 304) within the given fraud prevention image 228. Facial images 230 may correspond to a portion of fraud prevention images 228 including the portion thereof that includes the user face, such as facial regions 302, 402, and 502. Card images 232 may correspond to a portion of a fraud prevention image 228 including the portion thereof that includes the card, such as card region 304, 404, 504. It should be appreciated that facial images 230 may be separately stored files than card images 232, in embodiments. In embodiments, facial images 230 and card images 232 may still be portions of a single image, but further processing thereof is done only on the respective portions.

Facial recognition algorithm 214 analyzes facial images 230 to generate a current facial signature 234. In embodiments, facial recognition algorithm 214 is the same as that which was used during enrolment of the user 102 by enroller 210, as discussed above.

Card recognizer 222 analyzes card images 232 to generate a card signature 236. Card signature (or “device signature”) as used herein relates to a collection of data from one or more images taken of the card/device, as opposed to the signature of the cardholder commonly found on the back of a payment card. Card signature 236 may include information about card 104. In embodiments, card recognizer 222 includes at least one text recognition algorithm to identify information on card 104, such as card number, cardholder name, CCV number, expiration date, etc.

Facial authenticator 224 compares current facial signature 234 against enrolled facial signature 216 to generate authentication token 238. For example, facial authenticator 224 may analyze the text string forming enrolled facial signature 216 against the text string forming the current facial signature 234 to determine if the current facial signature 234 matches the enrolled facial signature 216. Authentication token 238 may indicate such match, or also indicate a non-match. It should be appreciated that facial authenticator 224 may further include alignment algorithms for first aligning given features (i.e. a nose of the user 102) within each of the current facial signature 234 and the enrolled facial signature 216.

Transaction manager 225 may utilize information within card signature 236 as part of the transaction approval process. For example, transaction manager 225 may autofill required information for a transaction with information within card signature 236, such as card number, cardholder name, CCV number, expiration date, etc. At which time, a transaction approval request 144, typically including an authentication token 238, may be transmitted to either merchant 110 or card manager 108. For example, if the user is attempting an online transaction via user device 106, the transaction manager 225 may automatically fill in the required transaction information within the website 134 and transmit a transaction approval request 144 to merchant 110.

Liveness detector 226 may include computer readable instructions that, when executed by processor 202, operate to determine liveness of the user within the fraud prevention image 228. In embodiments, liveness detector 226 can analyze 1) facial images 230 to determine liveness of the user within the fraud prevention image 228, 2) card images 232 to determine liveness of the user within the fraud prevention image 228 or 3) facial images 230 and card images 232. Liveness detector 226 may analyze only one facial image 230, or multiple thereof, and/or only one card image 232, or multiple thereof.

In embodiments including analyzing facial image(s) 230, liveness detector 226 may analyze the facial image(s) 230 to determine if the user 102 blinks within a sequence of facial images 230. For example, as shown in the sequence of facial regions 302, 402, 502 within FIGS. 3-5, the user 102 blinks in image 228(2). In embodiments of analyzing facial image(s) 230, liveness detector may analyze the facial image(s) 230 to determine if lighting characteristics change, or are at a given configuration within the facial image(s) 230.

In embodiments including analyzing card image(s) 232, liveness detector 226 may analyze the card image(s) 232 to determine movement of the card 104 within a sequence of card images 232. For example, as shown in the sequence of card regions 304, 404, 504 within FIGS. 3-5, card 104 is flipped from facing forward to backward.

In embodiments including liveness detector 226, the authentication token 238 may further be based on the analysis from liveness detector 226. For example, the authentication token 238 may only verify the user 102 if both (1) the user 102 is authenticated by facial authenticator 224, and (2) the user 102 is found to be a live user by the liveness detector 226. Therefore, a fraudulent user cannot merely hold up a picture of the actual user to “trick” system 100 into inaccurately authenticating a user.

In embodiments, authentication token 238 may include information determined by card recognizer 222. In embodiments, authentication token 238 utilizes card signature 236 to generate transaction approval request 144 to begin a transaction using card 104. For example, if enrolled facial signature 216 is associated with enrolled card information 215, as discussed above, authentication token 238 may be generated only if card signature 236 matches enrolled card information 215 and facial authenticator 224 verifies the user holding the card within the fraud prevention images 228 holding the correct card.

Although shown within user device 106, fraud manager 218 may be completed within card manager 108 without departing from the scope hereof. Authentication toke 238 may be utilized by fraud manager 218 to generate transaction approval request 144. In other words, one or more of information including card signature 236, current facial signature 234, a comparison of current facial signature 234 to enrolled facial signature 216, and liveness detector 226 may be utilized to generate transaction approval request 144.

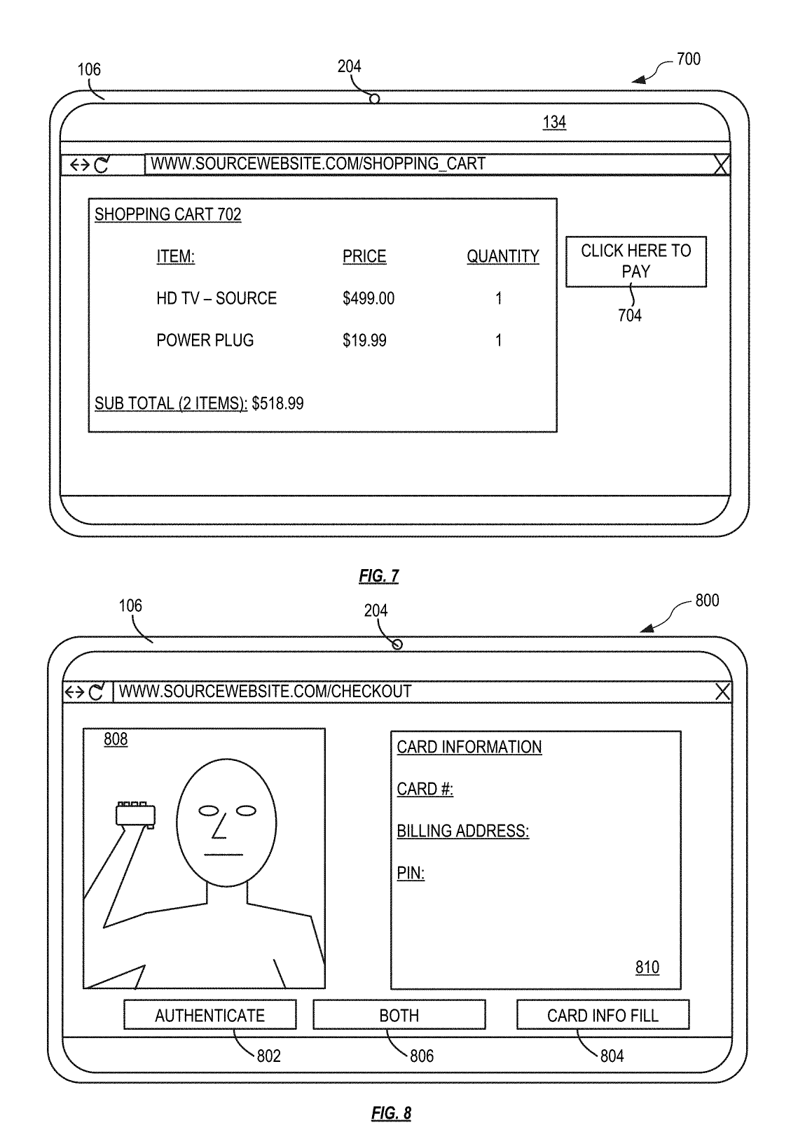

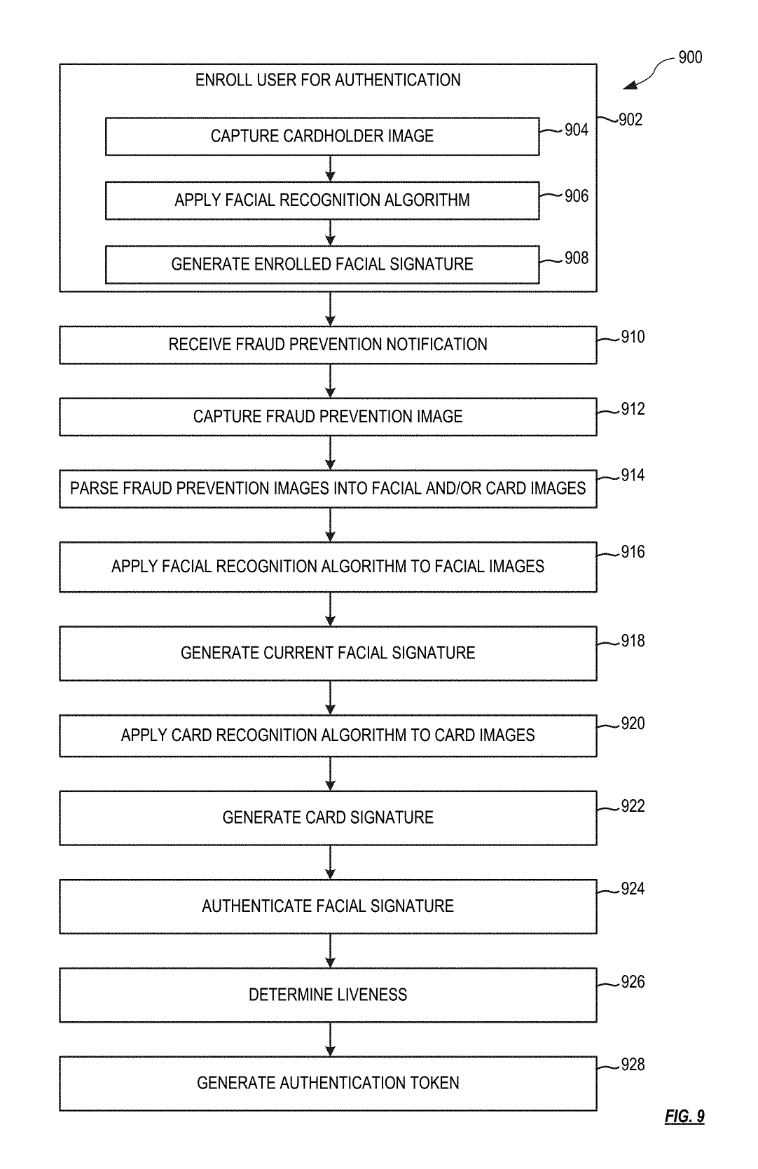

FIG. 7 depicts an exemplary user device 106 displaying a shopping cart view 700 of website 134 during operation of system 100, of FIG. 1, in embodiments. FIG. 8 depicts an exemplary user device 106 displaying checkout view 800 of website 134 during operation of system 100, of FIG. 1, in embodiments. FIGS. 7-8 are best viewed together with the following example description of how fraud is prevented as envisioned by embodiments herein.

Shopping cart view 700 is an embodiment of website 134. A user may purchase items from merchant, in this example, an HDTV and a power plug therefore, having sub total of $518.99. The user may then click a payment button 704. Source server plugin 119 may be configured to automatically generate fraud prevention notification 140, which, in turn may cause user device 106 to display checkout view 800. As shown in checkout view 800, the user may be presented with various options. For example, the user may be presented with one or more of an authenticate option button 802, a card info fill option button 804, and a both option button 806.

Authenticate option button 802 enacts aspects of fraud manager 218, discussed above, to generate authentication token 238. User 102 may interact with image capture device 204 and fraud prevention image display portion 808 such that fraud manager 218 generates authentication token 238 as discussed above. In embodiments, a user 102 cannot complete the checkout until authenticate option button 802 has been pressed and the user has been authenticated based on a generated authentication token 238. In embodiments, authenticate option button 802 automatically initiates generation of transaction approval request 144 after generation of authentication token 238.

Card info fill option button 804 enacts aspects of fraud manager 218, discussed above, to generate card signature 236. The information within card signature 236 may be used to automatically fill in card information section 810. Furthermore, in embodiments, card info fill option button 804 may automatically initiate generation of transaction approval request 144.

In embodiments including “both” option button 806, both aspects of authenticate option button 802 and card info fill option button 804 are enacted. In other words, “both” option button 806 may initiate generation of transaction approval request 144 based on the card signature 236 and a comparison of the current facial signature 234 to enrolled facial signature 216.

FIG. 9 depicts an exemplary method 900 for authentication using an image of a cardholder, in embodiments. Method 900 may be implemented using system 100 as discussed above with respect to FIGS. 1-8.

In step 902 of method 900, a user is enrolled for authentication. In embodiments of step 902, a cardholder utilizes enroller 210 to enroll with system 100 such that the cardholder may respond to a received fraud prevention notification 140 during use of card 104. Step 902 may be performed within user device 106, card manager 108, or a combination thereof. Step 902 may include sub-steps 904, 906, and 908.

In sub-step 904, an image of the cardholder is captured. In one embodiment of sub-step 904, image capture device 204 captures cardholder image 212. Method 900 then proceeds with sub-step 906.

In sub-step 906, a facial recognition algorithm is applied to the cardholder image captured during sub-step 904. In one embodiment of sub-step 906, facial recognition algorithm 214 is applied to cardholder image 212.

In sub-step 908, an enrolled facial signature is generated. In one embodiment of sub-step 908, enrolled facial signature 216 is generated by enroller 210 based upon facial recognition algorithm 214.

In step 910, a fraud prevention notification is received. In embodiments of step 910, fraud prevention notification 140 is generated in response to a transaction, identified by source server plugin 119, initiated between user 102 and merchant 110 on website 134. For example, user 102 may click payment button 704, at a shopping cart screen 700 of website 134. In embodiments of step 910, fraud prevention notification 140 is generated in response to a transaction, identified by source server plugin 119, initiated between user 102 and merchant 110 on POS device 132.

In step 912, at least one fraud prevention image is captured. In embodiments of step 912, at least one fraud prevention image 228 is captured via image capture device 204. In embodiments of step 912, a single or multiple fraud prevention images (e.g., multiple still images or video) 228 are captured. In embodiments of step 912, fraud prevention images 228 are captured using a template 600 displaying one or both of a facial indicator 602 and a card indicator 604.

In step 914, the fraud prevention image(s) 228 captured during step 912 are parsed into at least one of facial images and card images.

In step 916, a facial recognition algorithm is applied to the parsed facial images from step 914. In embodiments of step 916, the facial recognition algorithm used in step 916 is the same as that used in sub-step 906.

In step 918, a current facial signature is generated. In embodiments of step 918, current facial signature 234 is generated by fraud manager 218 based upon facial recognition algorithm 214.

In step 920, a card recognition algorithm is applied to the card images. In embodiments of step 920, card recognizer 222 analyzes card images 232 using a text recognition algorithm or other algorithm.

In step 922, a card signature is generated. In embodiments of step 922, card signature 236 is generated including information obtained about card 104 within card images 232. In embodiments of step 922, card signature 236 is used to auto-fill information within merchant 110, for example within card information section 810 of FIG. 8.

Although shown in series with steps 920 and 922, steps 916 and 918 may be performed in parallel with steps 920 and 922. Moreover, one or more of steps 916, 918, 920, and 922 may not be performed at all.

In step 924, the current facial signature generated during step 918 is authenticated. In embodiments of step 924, facial authenticator 224 compares current facial signature 234 against enrolled facial signature 216 to determine a match there between.

In step 926, liveness of the user captured during step 912 is determined. In embodiments of step 926, liveness detector 226 can analyze facial images 230, card images 232, or both to determine liveness of the user 102. For example, liveness detector 226 may analyze the facial image(s) 230 to determine if the user 102 blinks within a sequence of facial images 230. As another example, liveness detector 226 may analyze the facial image(s) 230 to determine if lighting characteristics change, or are at a given configuration within the facial image(s) 230. As another example, liveness detector 226 may analyze the card image(s) 232 to determine if the card 104 moves, such as whether the card is flipped from front to back, within a sequence of card images 232.

In step 928, an authentication token is generated. In one example of step 928, authentication token 238 is generated based on one or both of the results of steps 924 and 926. In embodiments, authentication token 238 may be generated 1) based on card signature 235, 2) when the current facial signature 234 matches the enrolled facial signature 216 above a given threshold, 3) the user is determined to be a live user based on liveness detector 226, or 4) any combination of 1-3, above. In embodiments, authentication token 238 may be generated based on both the results of steps 922 and 924. For example, authentication token 238 may be generated by associating the facial signature 234 with the card signature 236 to authenticate the user. Authentication token 238 may also be generated by combining each of the facial signature 234 (e.g. determined in step 924), card signature 236 (e.g. determined in step 922) and the results of step 926 identifying that the user is a live user. Authentication token 238 may then be used to initiate transaction approval request 144. For example, in embodiments, authentication token 238 is transmitted, as at least a part of device transaction approval request 144, from device 106 to card manager 108 and subsequently used by authenticator 118 to authenticate the transaction between user 102 and merchant 110.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A fraud prevention system for authenticating a user, comprising:
a processor;
memory in communication with the processor, the memory including:
a fraud prevention image including a facial region of the user and a device region associated with the user, and
computer readable instructions executable by the processor to enable an image parser, a facial recognizer, a device recognizer, a communication manager, and an authenticator,
the image parser adapted to parse the fraud prevention image into a facial image and a device image,
the facial recognizer adapted to analyze the facial image to generate a current facial signature of the user,
the device recognizer adapted to analyze the device image to identify a device signature of a device within the device image,
the authenticator adapted to authenticate the user based at least on comparison to the current facial signature and an enrolled facial signature, and
the communication manager adapted to request a device verification based upon the device signature and the comparison of the current facial signature and the enrolled facial signature.

2. The fraud prevention system of claim 1,
the fraud prevention image including a sequence of fraud prevention images each including the facial region of the user and the device associated with the user,
the image parser adapted to parse the respective facial regions within each of the sequence of fraud prevention images into a respective facial image,
the image parser adapted to parse the respective device regions within each of the sequence of fraud prevention images into a respective device image, a first image of the device images including a front of the device, and a second image of the device images including a back of the device.

3. The fraud prevention system of claim 2, a third image of the sequence of images including the device in a rotated position.

4. The fraud prevention system of claim 2, the computer readable instructions further enabling a liveness detector adapted to analyze the sequence of images to verify liveness of the user within the sequence of images.

5. The fraud prevention system of claim 4, the liveness of the user being determined based on recognition of the front of the device and the back of the device within the sequence of images.

6. The fraud prevention system of claim 4, the liveness of the user being verified based on differences of the facial regions within the fraud prevention images.

7. The fraud prevention system of claim 4, further comprising an authentication token generated based on the liveness detector identifying the user as a live user, and the authenticator verifying the user based further on the authentication token.

8. The fraud prevention system of claim 1, the communication manager further adapted to auto-fill a website with the device signature.

9. The fraud prevention system of claim 1, the processor further in communication with a camera for capturing the fraud prevention image, the camera being activated in response to receipt of a fraud prevention notification.

10. The fraud prevention system of claim 9, the fraud prevention notification being received in response to an attempt to use the device in a device-not-present transaction.

11. The fraud prevention system of claim 1, further including an enroller for enrolling the user within the fraud prevention system, the enroller generating an enrolled facial signature based on an application of a facial recognition algorithm to a device holder image captured by a camera.

12. A method for preventing fraud by authenticating a user, comprising:
capturing a fraud prevention image of the user including a facial region of the user and a card region of a card associated with the user;
parsing the fraud prevention image into a facial image and a card image;
analyzing the facial image to generate a current facial signature;
analyzing the card image to generate a card signature;
generating an authentication token based on a comparison of the current facial signature to an enrolled facial signature; and,
requesting a transaction approval based on the card signature and the authentication token.

13. The method of claim 12, the generating the authentication token including comparing enrolled card information to the card signature.

14. The method of claim 12, the capturing a fraud prevention image occurring in response to receipt of a fraud prevention notification generated in response to an attempted transaction associated with the card.

15. The method of claim 12, the capturing a fraud prevention image including capturing a sequence of fraud prevention images, the step of generating an authentication token including determining liveness of the user based on the sequence of images.

16. The method of claim 15, liveness of the user being determined based on movement of the card within the sequence of fraud prevention images.

17. The method of claim 15, liveness of the user being determined based on a change in the user within the sequence of fraud prevention images.

18. A non-transitory computer readable medium with computer executable instructions stored thereon executed by a processor to perform fraud prevention, comprising instructions for:
analyzing a fraud prevention image, including a facial region of a user and a card region of a card associated with a cardholder, to generate a current facial signature and a card signature; and,
generating an authentication token based on a comparison of the current facial signature of the user to an enrolled facial signature of the cardholder.

19. The non-transitory computer readable medium of claim 18, further comprising instructions for accessing an image capture device to acquire a fraud prevention image in response to receipt of a fraud prevention notification.

20. The non-transitory computer readable medium of claim 18, further comprising instructions for enrolling a cardholder to generate the enrolled facial signature.
